(19) United States
(12) Patent Application Publication
(10) Pub. No.: US 2015/0339858 A1
(43) Pub. Date: Nov. 26, 2015

(54) INFORMATION PROCESSING DEVICE, INFORMATION PROCESSING SYSTEM, AND INFORMATION PROCESSING METHOD

(71) Applicant: FUJITSU LIMITED, Kawasaki-shi (JP)

(72) Inventor: Ken Nakamura, Kawasaki (JP)

(21) Appl. No.: 14/710,892

(22) Filed: May 13, 2015

(30) Foreign Application Priority Data
May 23, 2014 (JP) 2014-106891

(51) Int. Cl. G06T 19/00

(52) U.S. Cl. CPC G06T 19/006

(57) ABSTRACT

An information processing device configured to display a first display image on a display unit based on display information and first position information acquired based on identification information associated with the display information, the information processing device includes a memory, and a processor coupled to the memory, configured to acquire imaged images imaged by an imaging unit, extract the identification information from an object included in each of the imaged image, acquire the display information associated with the identification information when the identification information is extracted by the extraction, and display a second display image on the display unit based on second position information and the display information acquired by the acquisition, when the identification information is not extracted from any of the imaged images acquired after the identification information is extracted by the extraction.

### CROSS-REFERENCE TO RELATED APPLICATION

This application is based upon and claims the benefit of priority of the prior Japanese Patent Application No. 2014-106891, filed on May 23, 2014, the entire contents of which are incorporated herein by reference.

### FIELD

The embodiments discussed herein are related to an information processing device, an information processing system, and an information processing method.

### BACKGROUND

In recent years, a system using the augmented reality (AR) technology has been utilized in various fields such as a factory, an exhibition, a museum and the like. The AR technology is a technology which provides display in which AR display information is superimposed on information of a real image.

For example, it is proposed to utilize the AR technology as a field work support system which supports field work in a factory or the like. Using the AR technology, the field work support system supports field work by providing workers with information useful for the field work.

The field work support system images an AR marker placed on an object to be manipulated and acquires an ID thereof by performing image recognition. The system acquires AR display information on work content/procedure and the like based on the acquired ID, and superimposes and displays the AR display information on the imaged image of the object to be manipulated. This display may be presented by using information suitable to the object to be manipulated, such as display of a manual to maintenance personnel or display of an input field for measured data to an inspector. These technologies are disclosed in Japanese Laid-open Patent Publications No. 10-51711 and 2012-68984.

### SUMMARY

According to an aspect of the invention, an information processing device configured to display a first display image on a display unit based on display information and first position information acquired based on identification information associated with the display information, the information processing device includes a memory, and a processor coupled to the memory, configured to acquire imaged images imaged by an imaging unit, extract the identification information from an object included in each of the imaged image, acquire the display information associated with the identification information when the identification information is extracted by the extraction, and display a second display image on the display unit based on second position information and the display information acquired by the acquisition, when the identification information is not extracted from any of the imaged images acquired after the identification information is extracted by the extraction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic view of a hardware configuration of an information processing system according to a first embodiment;

FIG. 2 is a functional block diagram of the information processing system according to the first embodiment;

FIG. 3 is a view illustrating information that an AR marker used in the information processing system according to the first embodiment has;

FIG. 4 is a view illustrating definition information of AR display information associated with the AR marker used in the information processing system according to the first embodiment;

FIG. 5A is a transition diagram of a screen displayed on a head-mounted display 100 used in the information processing system according to the first embodiment;

FIG. 5B is a transition diagram of the screen displayed on the head-mounted display 100 used in the information processing system according to the first embodiment;

FIG. 5C is a transition diagram of the screen displayed on the head-mounted display 100 used in the information processing system according to the first embodiment;

FIG. 6 is an example of a flow chart of processing of the head-mounted display 100 according to the first embodiment;

FIG. 7 is an example of a flow chart of processing of a smartphone according to the first embodiment;

FIG. 8 is an example of a flow chart of processing of a head-mounted display according to a second embodiment;

FIG. 9 is a view illustrating information on detected acceleration; and

FIG. 10 is an example of a flow chart of processing of the smartphone according to the second embodiment.

### DESCRIPTION OF EMBODIMENTS

A field work support system has an imaging unit, such as a camera and the like, configured to image an AR marker, a database in which AR display information associated with an ID is stored, an information processing unit configured to acquire from the database the AR display information associated with the ID which is extracted from the AR marker, and a display unit configured to display a generated display image.

For AR display information displayed in the field work support system, a display position is determined and a display image is generated based on position information specified in association with an AR marker. For example, the position information is specified such that the AR display information will be displayed away from the AR marker at a distance of two or more times of the AR marker. And the display image is generated such that the AR display information is arranged away from the imaged AR marker at the specified distance.

Thus, the display image including the AR display information is displayed only while the AR marker is being imaged.

In some cases, however, it is desirable that the display image including the AR display information continue to be displayed. The cases particularly include a case where a user is in a working range of an object to be manipulated but does not face a direction of the object to be manipulated. For example, there is a case where a user stays in the working range of the object to be manipulated and desires to have information of the display image including the AR display information, but the user does not face the direction of the object to be manipulated, that is to say, the imaging unit does not image the AR marker. In this case, the user may not utilize the AR display information since the display image including the AR display information is not displayed.

The embodiments are made in light of the problem described above, and provide an information processing device, an information processing system, and an information processing method which are configured to display AR display information requested by a user.

Examples of an information processing device, an information processing system, and an information processing method are described hereinafter in detail with reference to the drawings. Note that the examples do not limit the technology of the disclosure.

### First Embodiment

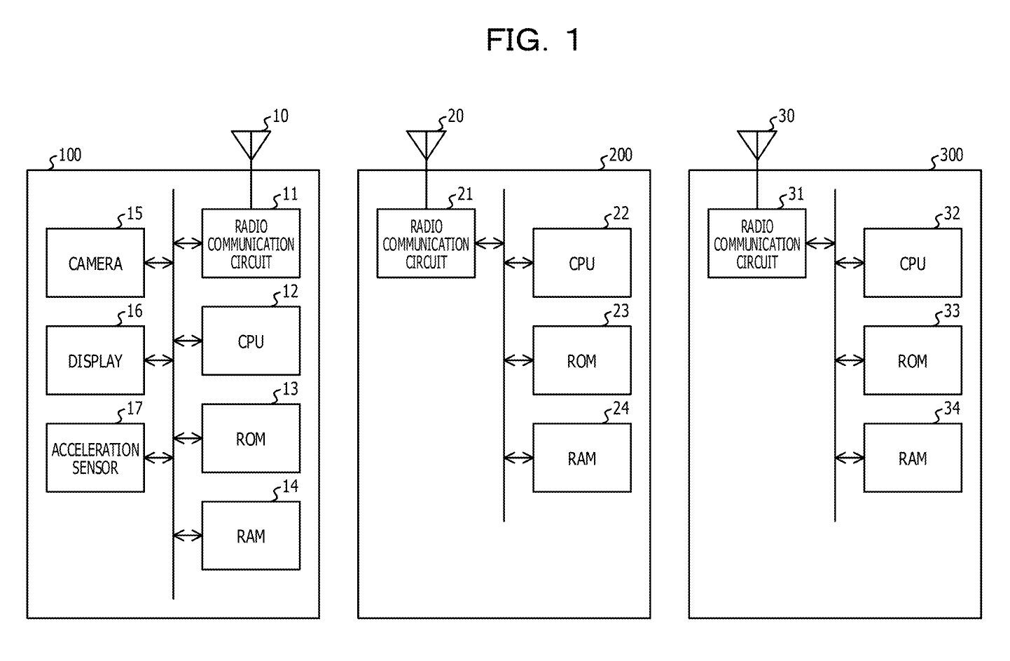

FIG. 1 is a schematic view of a hardware configuration of an information processing system according to a first embodiment. In the first embodiment, a description is given using a smartphone as an information processing device, a head-mounted display as a display device, and a server device as a storage device. An information processing device, a display device, and a storage device are not limited to a combination of a smartphone, a head-mounted display, and a server device. A tablet computer and the like may be used as an information processing device. In addition, an information processing device may be a device into which an information processing device, a display device, and a storage device are integrated.

Hardware Configuration of a Head-Mounted Display

As illustrated in FIG. 1, a head-mounted display 100 has, as hardware components, a radio communication circuit 11 connected to an antenna 10, a CPU 12, a ROM 13, a RAM 14, a camera 15, and a display 16 configured to display a screen, and an acceleration sensor 17. These hardware modules (hardware components) are connected to each other by a bus, for example.

The CPU 12 acts as a control unit 102 configured to perform information processing to be described below, by reading and executing various programs stored in the ROM 13. The ROM 13 stores the various programs executed by the CPU 12. The various programs include an application program run by the head-mounted display 100 or an operation system (OS) which are held in the ROM 13 even when the power of the head-mounted display 100 is turned off. The RAM 14 is used as a storage area where the CPU 12 deploys data such as the OS in the ROM 13 and the like.

Provided at a position corresponding to user's eye level with a user wearing the head-mounted display 100, the camera 15 is configured to image an object to be manipulated.

The display 16 of the head-mounted display 100 has transparency. A display image including AR display information is displayed on the display 16. While visually confirming a display screen displayed on the display 16, the user may visually confirm the surrounding situation of an object to be manipulated and the like through the display 16 having transparency.

The acceleration sensor 17 detects acceleration when the head-mounted display 100 moves. The acceleration sensor 17 may not be provided in the first embodiment.

Hardware Configuration of a Smartphone

A smartphone 200 has a radio communication circuit 21 connected to an antenna 20, a CPU 22, a ROM 23, and a RAM 24, as a hardware component. These hardware modules (hardware components) are connected to each other by a bus, for example.

The CPU 22 acts as an image acquisition unit 202, an identification information extraction unit 203, a display information acquisition unit 204, a display control unit 205 to be described below by reading and executing various programs stored in the ROM 23. The ROM 23 stores the various programs executed by the CPU 22. The various programs include an application program run by the smartphone 200 or an operation system (OS) which are held in the ROM 23 even when the power of the smartphone 200 is turned off. The RAM 24 is used as a storage area where the CPU 22 deploys data such as the OS in the ROM 23 and the like.

Hardware Configuration of a Server Device

A server device 300 has, as a hardware components, a radio communication circuit 31 connected to an antenna 30, a CPU 32, a ROM 33, and a RAM 34. These hardware modules (hardware components) are connected to each other by a bus, for example.

The radio communication circuits 11, 21, and 31 are used for communications with external devices. In this embodiment, a radio communication unit is used for connecting to a network such as a mobile communication network and the like. As a communication method, the server device 300 may use Ethernet (registered trademark) for wired communications, instead of using wireless communications.

The CPU 32 acts as a control unit 302 configured to perform information processing to be described below, by reading and executing various programs stored in the ROM 33. The ROM 33 stores the various programs or data executed by the CPU 32. The various programs include an application program run by the server device 300 or an operation system (OS) and the like. The ROM 33 stores a database configured to store AR display information corresponding to identification information given to an AR marker and definition information of the AR display information. A database is described below. The RAM 34 is used as a storage area where the CPU 32 deploys data such as the OS in the ROM 33 and the like.

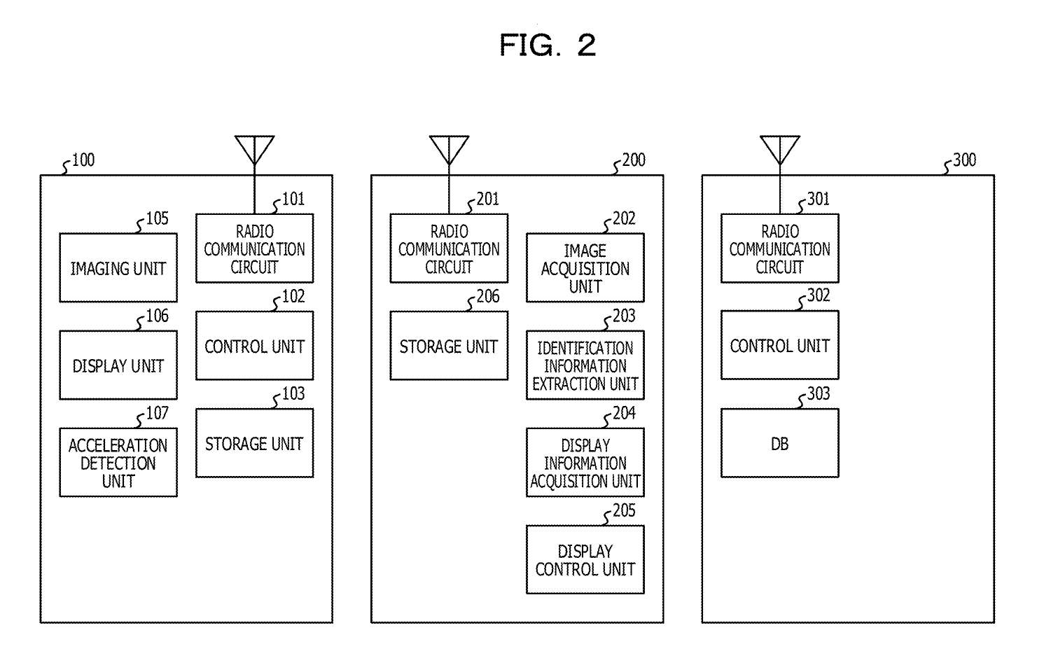

Function blocks of the information processing system according to the first embodiment are described hereinafter. FIG. 2 is a functional block diagram of the information processing system according to the first embodiment.

Functional Blocks of a Head-Mounted Display

As illustrated in FIG. 2, the head-mounted display 100 has the following functional blocks. The head-mounted display 100 has a radio communication unit 101 configured to perform radio communications with the smartphone 200 by using the radio communication circuit 11; a control unit 102 configured to perform controls to be described below, by causing the CPU 12 to execute various programs stored in the ROM 13; a storage unit 103 configured to use the ROM 13 to store various programs and imaged image data; an imaging unit 105 configured to use the camera 15 to image an object to be manipulated; a display unit 106 configured to display a display image on the display 16; and an acceleration detection unit 107 configured to use the acceleration sensor 17 to detect acceleration of movement of the head-mounted display 100. The imaging unit 105 continuously performs imaging.

The acceleration detection unit 107 may not be provided in the first embodiment.

Functional Blocks of a Smartphone

As illustrated in FIG. 2, the smartphone 200 has the following functional blocks. The smartphone 200 has a radio communication unit 201 configured to use the radio communication circuit 21 to perform radio communications with the head-mounted display 100 and the server device 300; an image acquisition unit 202, an identification information extraction unit 203, a display information acquisition unit 204, and a display control unit 205 which are configured to perform controls to be described below by causing the CPU 22 to execute various programs stored in the ROM 23; and a storage unit 206 configured to use the ROM 23 to store various programs, acquired imaged images, AR display information, and definition information of the AR display information.

Functional Blocks of a Server Device

As illustrated in FIG. 2, a server device 300 has the following functional blocks. The server device 300 has a radio communication unit 301 configured to use a radio communication circuit 31 to perform radio communications with a smartphone 200; a control unit 302 configured to perform controls to be described below by causing the CPU 32 to execute various programs stored in the ROM 33; and a database (DB) 303 configured to use the ROM 33 to store a database storing various programs, AR display information corresponding to identification information given to an AR marker, and definition information of the AR display information.

Information Processing Method

In an information processing system according to the first embodiment are used a head-mounted display 100 which is a display unit having an imaging unit and a display unit, a server device 300 which is a storage device configured to store a definition table of AR display information associated with identification information extracted from an AR marker, and a smartphone 200 which is an information processing device.

An image acquisition unit 202 of the smartphone 200 acquires an imaged image which is imaged by an imaging unit 105 of the head-mounted display 100. An identification information extraction unit 203 extracts identification information from an AR marker included in the imaged image.

The identification information extraction unit 203 identifies an AR marker from the imaged image including the AR marker, by a pattern matching technique and the like, analyzes a pattern in the AR marker, and acquires identification information such as a marker ID and the like. The identification information extraction unit 203 analyzes a positional relationship of the head-mounted display 100 and the AR marker from size and distortion of a frame of the AR marker. The pattern matching technique is a technique to identify whether a specific graphic pattern is included in an imaged image as well as what position the specific graphic pattern is located at, and extract identification information by using the specified graphic pattern.

A display information acquisition unit 204 acquires AR display information associated with identification information from a server device 300 when the identification information is extracted by the identification information extraction unit 203.

A display control unit 205 displays a display image including the AR display information on the head-mounted display 100 based on arrangement information indicating a position to arrange the AR display information which is first position information acquired from the server device 300. In addition, when no AR marker is included in an imaged image re-acquired after the identification information is once extracted by the identification information extraction unit 203, the display control unit 205 faces a situation where no identification information is extracted. When no identification information is extracted from any of the imaged images acquired after the identification information is once extracted, the display control unit 205 displays on the head-mounted display 100 the AR display information acquired and displayed on the head-mounted display 100 last time, based on second position information.

Here, the second position information is position information by which the AR display information is displayed at a predetermined position in the display unit of the head-mounted display 100.

AR display information, which is contents suitable to the situation such as work content/procedures and the like, may be acquired based on information on an ID or the like of an AR marker acquired through image recognition with a smart device such as the smartphone 200 held over the AR marker. For example, as the AR display information, information suitable to the situation of field work may be utilized for displaying a manual to maintenance personnel, an input field for measured data to an inspector, or the like. Furthermore, use of the information processing system of this embodiment enables an AR marker to be continuously displayed in a display screen even when the AR marker falls outside an imaging range. Therefore, AR display information requested by a user for work and the like may continuously be utilized.

In addition, the server device 300 manages contents or business information to be displayed in a collective manner. Such collective management enables contents displayed even for one and the same AR marker to be switched over depending on work content or a user who uses the AR marker. When the contents are cached on a smartphone, the desirable information can be acquired even when a workplace is an offline environment.

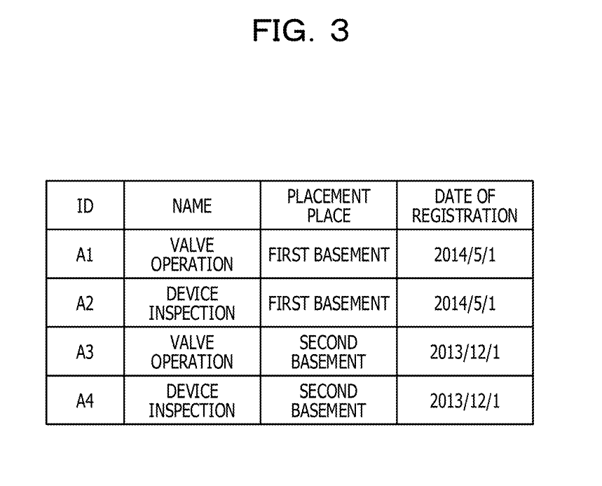

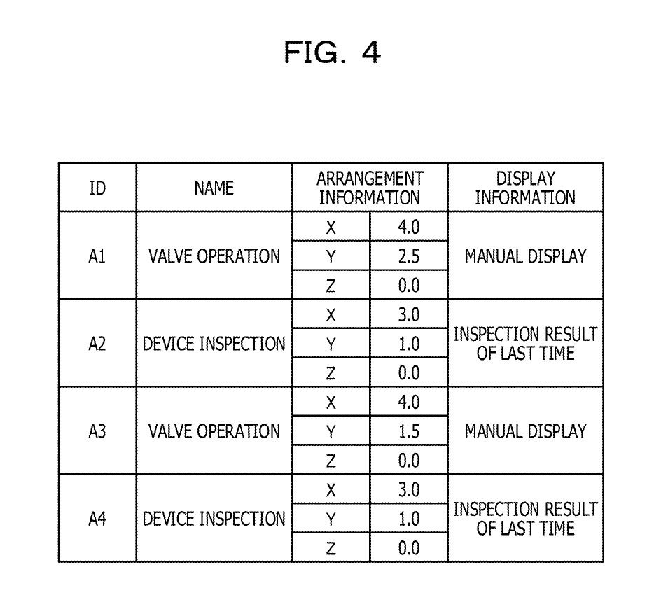

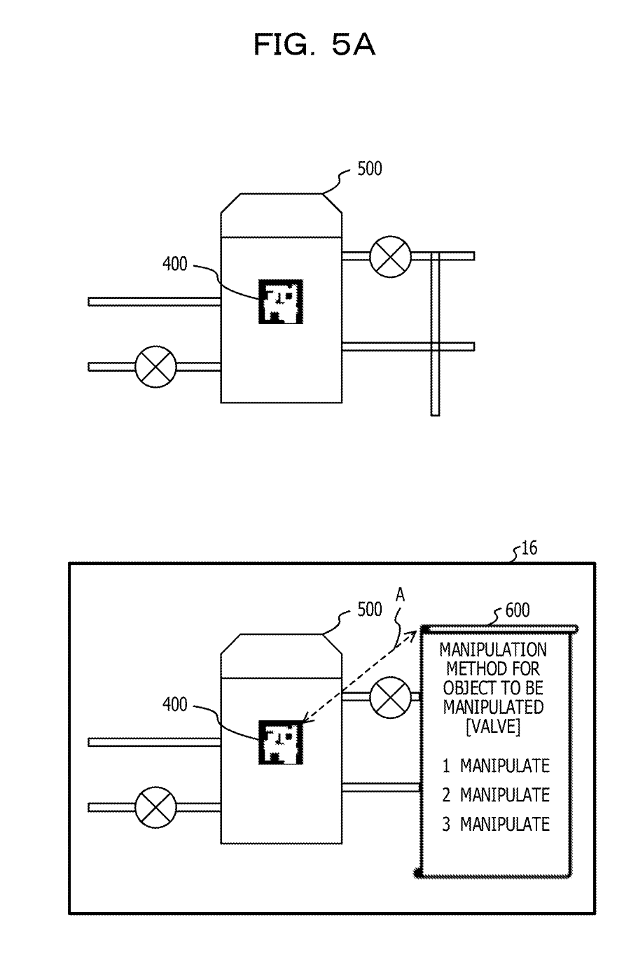

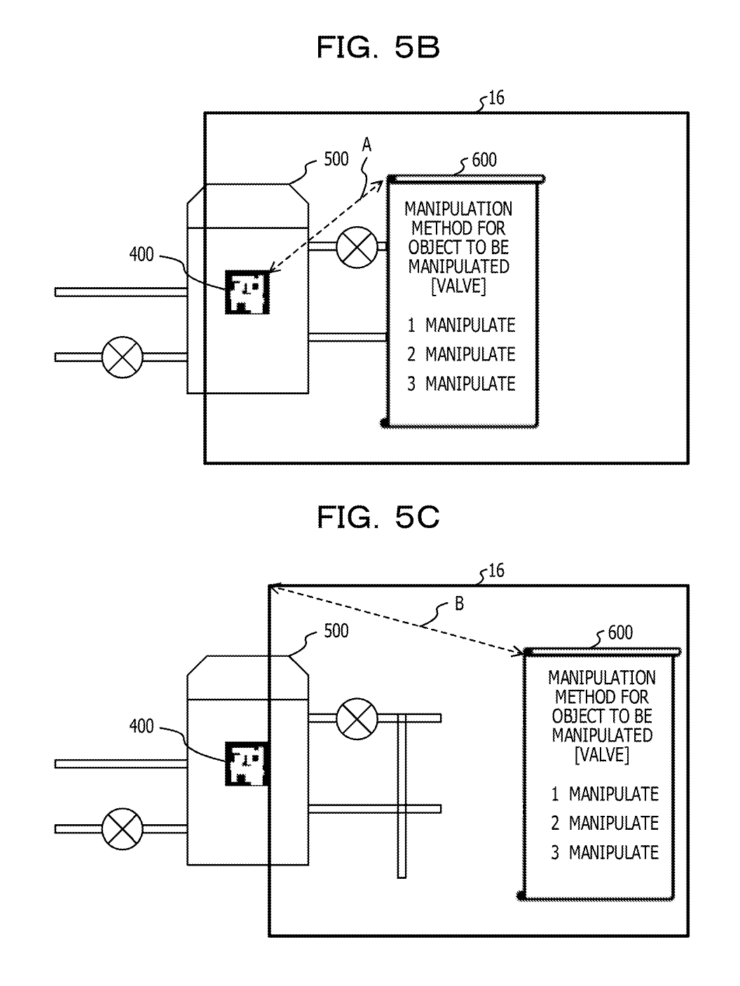

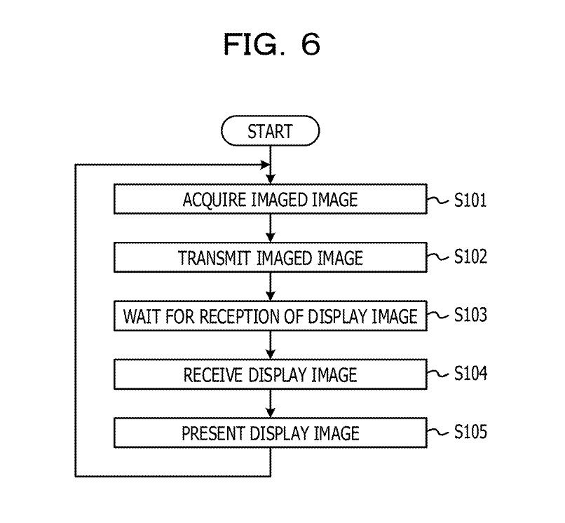

Now, a processing flow of the information processing system according to the first embodiment is described specifically. First, in FIG. 3 and FIG. 4, information that an AR marker used in the information processing system according to the first embodiment has and definition information of AR display information associated with the AR marker are described. FIG. 5A, FIG. 5B, and FIG. 5C illustrate transition of a screen displayed on the head-mounted display 100 when the information processing system according to the first embodiment is used. Then, in FIG. 6, the processing flow of the information processing system according to the first embodiment is described.

FIG. 3 is a view illustrating information that an AR marker used in the information processing system according to the first embodiment has.

An AR marker is used as an object from which identification information associated with AR display information is extracted. The AR marker is a two-dimensional code having a specific graphic pattern. Here, the AR marker is placed on a valve device 500. An AR marker is a marker called a maker type whose identification information is extracted through recognition of a graphic of a specific shape. As an object whose identification information is extracted may be used a markerless type object whose identification information is extracted through recognition of an object or space itself which physically exists in a real environment and not of a specific graphic. A markerless type object may be a valve device 500 which is an object to be manipulated. In this case, it is judged whether or not the valve device 500 is present in an imaged image, by storing in advance, as identification information, characteristic information of the valve device 500 extracted from the image which images the valve device 500 and comparing characteristic information extracted from the imaged image with the characteristic information stored in advance. Then, AR display information is acquired based on the stored identification information.

As illustrated in FIG. 3, the AR marker has information such as ID information, a name of AR display information, a placement place of the AR marker, a date when an AR marker is registered, and the like. The smartphone 200 extracts the information from an AR marker and acquires AR display information from the server device.

FIG. 4 illustrates definition information of AR display information associated with an AR marker used in the information processing system according to the first embodiment.

Definition information of AR display information is information associated with an AR marker in advance in order to superimpose and display the AR display information. In association with an ID of an AR marker, the definition information includes a name of AR display information, arrangement information on what position in a display image to arrange AR display information, manual display, and information indicating contents such as an inspection result of last time. The arrangement information is information indicating how far a position to arrange the AR display information is with respect to a predetermined point of the AR marker in directions X, Y, and Z. Information defined for the AR marker may also be information on which AR display information is to be displayed, and how large and at which angle the AR display information is to be displayed. In addition, information on whether or not to continue to display an AR marker even when the AR marker falls outside an imaging range may be set in advance and used to judge whether or not to perform display based on second position information.

FIG. 5A, FIG. 5B, and FIG. 5C are transition diagrams of a screen displayed in the head-mounted display 100 used in the information processing system according to the first embodiment.

FIG. 5A illustrates a valve device 500 having a valve which is an object to be manipulated on which an AR marker 400 is placed and a display 16 of the head-mounted display 100 which images the device.

The image acquisition unit 202 of the smartphone 200 acquires an imaged image which is imaged by the imaging unit 105 of the head-mounted display 100. The identification information extraction unit 203 extracts identification information from the AR marker 400 included in the imaged image. The display information acquisition unit 204 acquires AR display information 600 associated with identification information from the server device 300 when the identification information is extracted by the identification information extraction unit 203.

The display control unit 205 displays a display image including the AR display information 600 on the display 16 of the head-mounted display 100, based on arrangement information indicating a position to arrange the AR display information 600 which is first position information acquired from the server device 300.

A dot-line arrow A represents a distance from the AR marker 400 to the AR display information 600 based on the definition information illustrated in FIG. 4.

FIG. 5B illustrates a display screen of the display 16 when a user moves from a state in FIG. 5A to the right of the valve device 500 which is the object to be manipulated.

The head-mounted display 100 images at a predetermined interval such as a frame rate of the camera 15. The image acquisition unit 202 of the smartphone 200 re-acquires an imaged image which is imaged by the imaging unit 105 of the head-mounted display 100. The identification information extraction unit 203 extracts identification information from the AR marker 400 included in the imaged image. The display information acquisition unit 204 acquires the AR display information 600 associated with identification information from the server device 300 when the identification information is extracted by the identification information extraction unit 203.

The display control unit 205 displays a display image including the AR display information 600 on the display 16 of the head-mounted display 100 based on position information indicating a position to arrange the AR display information 600 which is first position information acquired from the server device 300.

FIG. 5C is a display screen of the display 16 when the user further moves from the states in FIG. 5A and FIG. 5B to the right of the valve device 500 which is the object to be manipulated.

The display control unit 205 of the smartphone 200 faces a situation where no identification information is extracted when no AR marker 400 is included in an imaged image re-acquired after the identification information is once extracted by the identification information extraction unit 203. When no identification information is extracted, the display control unit 205 displays on the head-mounted display 100 the AR display information 600 acquired and displayed on the head-mounted display 100 last time, based on the second position information.

A dot-line arrow B in the figure represents a distance from the AR marker 400 to the AR display information 600 based on the second position information. The second position information is position information by which the AR display information 600 is displayed at a predetermined position in the display unit of the head-mounted display 100.

The second position information may use a position where the AR display information 600 is displayed when the AR marker 400 is lastly acquired or may be predefined as such a position that the visibility of the user looking at a real image can be ensured, such as a position to the right or left of the display screen. The second information may also be determined when desired, from definition information for the AR marker, such as information on which AR display information 600 is to be displayed and how large and at which angle the AR display information 600 is to be displayed.

Thus, when the information processing system of this example is used, an AR marker continues to be displayed in a display screen even when the AR marker falls outside an imaging range. Therefore, AR display information requested by a user for work and the like may continuously be utilized.

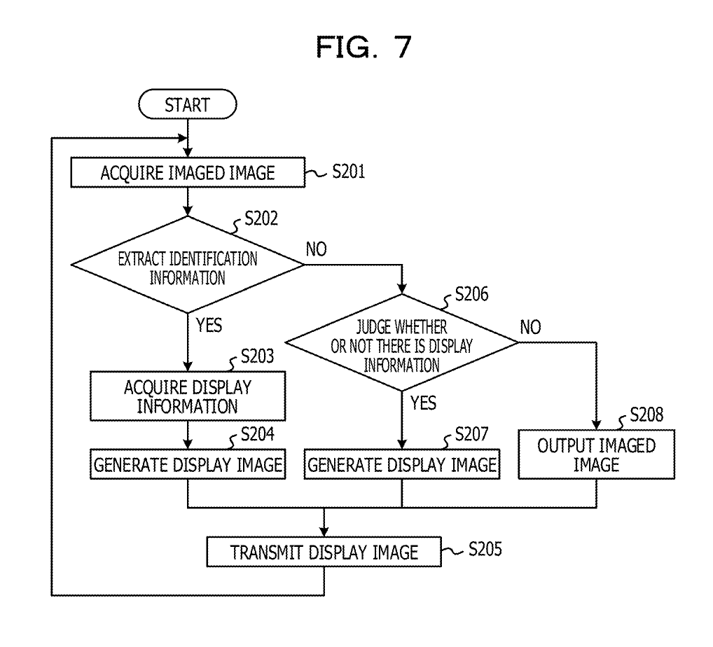

Next, the processing flow of the information processing system according to the first embodiment is described with reference to FIG. 6 and FIG. 7. FIG. 6 is an example of a flow chart of processing of the head-mounted display 100 according to the first embodiment.

When performing work to manipulate the valve device 500 which is an object to be manipulated, the user performs the work wearing the head-mounted display 100. The head-mounted display 100 is a display device to be mounted to the head. The head-mounted display 100 has a binocular or monocular glass type. The head-mounted display 100 may also be of a transparent type that allows a user to visually confirm a projected AR display image while visually confirming the outside situation or of a non-transparent type that allows the user to confirm the outside situation through superimposed display of a real image and AR display information although the user may not visually confirm the outside situation directly. Note that this example is not limited to a head-mounted display and may be a tablet computer or a smartphone and the like, which is equipped with a camera.

The control unit 102 of the head-mounted display 100 acquires an imaged image (S101) which is imaged by the imaging unit 105 using the camera 15. The control unit 102 transmits the imaged image to the smartphone 200 (S102), and waits (S103) till the control unit 102 receives a display image to be displayed on the display 16 from the smartphone 200.

The control unit 102 receives the display image (S104) transmitted from the smartphone 200 via the radio communication unit 101, and presents the received display image on the display unit 106 (S105).

The display image to be received from the smartphone 200 is a display image generated based on AR display information and definition information of the AR display information or a display image not including the AR display information. The display image not including the AR display information is a display image which is an as-is imaged image. When a head-mounted display of transparent type is used, the control unit 102 does not receive a display image not including the AR display information itself, and causes the user to view the outside situation directly.

When the head-mounted display 100 receives a display image including AR display information, the display as illustrated in the display 16 in FIG. 5A, FIG. 5B, and FIG. 5C appears.

FIG. 7 is an example of a flow chart of processing of the smartphone 200 according to the first embodiment.

The image acquisition unit 202 of the smartphone 200 acquires an imaged image (S201) transmitted from the head-mounted display 100 via the radio communication unit 201.

The identification information extraction unit 203 extracts identification information (S202) such as the AR marker illustrated in FIG. 3 from the imaged image acquired by the image acquisition unit 202. When the AR marker is included in the imaged image, identification information of the AR marker is extracted (S202: Yes).

When identification information is extracted by the identification information extraction unit 203, the display information acquisition unit 204 transmits the identification information to the server device 300 via the radio communication unit 201 and receives from the server device 300 and acquires (S203) AR display information associated with the identification information and definition information of the AR display information, which are stored in the DB 303 of the server device 300, via the radio communication unit 301. Here, the control unit 302 of the server device 300 transmits the AR display information and the definition information of the AR display information in the DB 303 to the smartphone 200 (not illustrated) based on the identification information received via the radio communication unit 301. The AR display information is such content as manual display, an inspection result of last time and the like. In association with an ID of an AR marker, the definition information of the AR display information includes a name of AR display information, arrangement information on what position in a display image to arrange AR display information, and information indicating whether to display contents as AR display information.

Here, the display control unit 205 uses the acquired AR display information to generate a display image (S204) to be displayed on the head-mounted display 100. The display control unit 205 arranges contents, which is AR display information, in the display image based on the arrangement information of the definition information of the AR display information. The arrangement information is information indicating how far the AR display information is to be arranged from a predetermined point of the AR marker in directions X, Y, and Z.

The display control unit 205 transmits the generated display image (S205) to the head-mounted display 100 via the radio communication unit 201. The image acquisition unit 202 waits to acquire the imaged image again.

On the one hand, when the identification information is not extracted by the identification information extraction unit 203 (S202; No), the display control unit 205 judges whether or not there is any AR display information already acquired (S206).

If the display control unit 205 judges that there is the AR display information (S206; Yes), the display control unit 205 generates a display image to be transmitted to the head-mounted display 100, based on the second position information from the AR display information acquired and displayed on the head-mounted display 100 last time (S207). The second position information is position information by which the AR display information is displayed at a predetermined position in the display unit of the head-mounted display 100. The second position information may use a position where the AR display information is displayed when the AR marker is lastly acquired or may be predefined as such a position that the visibility of the user looking at a real image can be ensured, such as a position to the right or left of the display screen. The second information may also be determined when desired from definition information for the AR marker, such as information on which AR display information 600 is to be displayed and how large and at which angle the AR display information 600 is to be displayed.

The display control unit 205 transmits the generated display image (S205) to the head-mounted display 100 via the radio communication unit 201. The image acquisition unit 202 waits to acquire the imaged image again.

In addition, if the display control unit 205 judges that there is no AR display information (S206; No), the display control unit 205 outputs the acquired imaged image (S208) and transmits the acquired imaged image (S205) to the head-mounted display 100 via the radio communication unit 201. This imaged image is a display image not including the AR display information. When a head-mounted display of transparent type is used for the head-mounted display 100, a configuration may be such that the imaged image is not transmitted, and an instruction to cancel waiting for reception of the display image is transmitted so that the head-mounted display 100 does not display the display image. In this case, in the head-mounted display 100, no display image is received, waiting for reception of the display image is cancelled, and an imaged image is acquired again.

Thus, when the information processing system of this embodiment is used, an AR marker continues to be displayed in a display screen even when the AR marker falls outside an imaging range. Therefore, AR display information requested by a user for work and the like may continuously be utilized.

### Second Embodiment

An information processing system according to a second embodiment is described. A hardware configuration and functional blocks of the information processing system according to the second embodiments are similar to the hardware configuration and the functional blocks illustrated in FIG. 1 and FIG. 2.

In the second embodiment, AR display information is continuously kept displayed in a range in which a user works on an object to be manipulated. When it is judged that the user moves out of the work range, the display of the AR display information is cancelled. Thus, the AR display information is displayed only in a work range requested by the user, and the visibility of the user wearing a head-mounted display 100 is improved when the user does not desire the display of the AR display information.

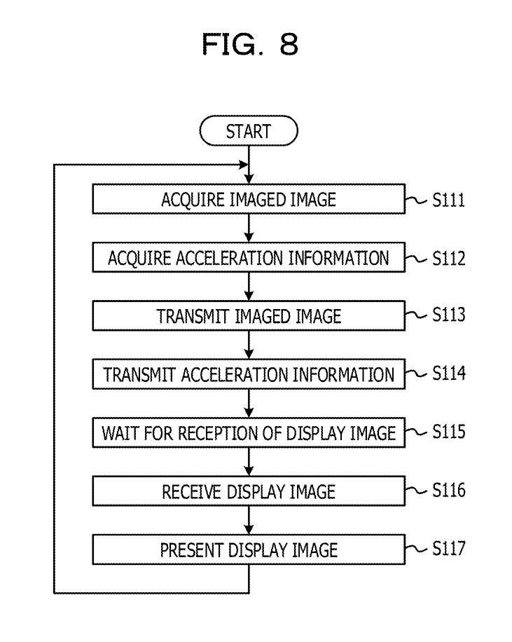

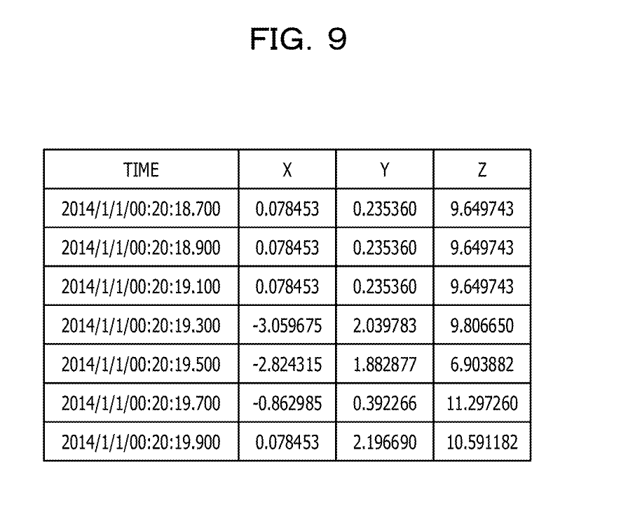

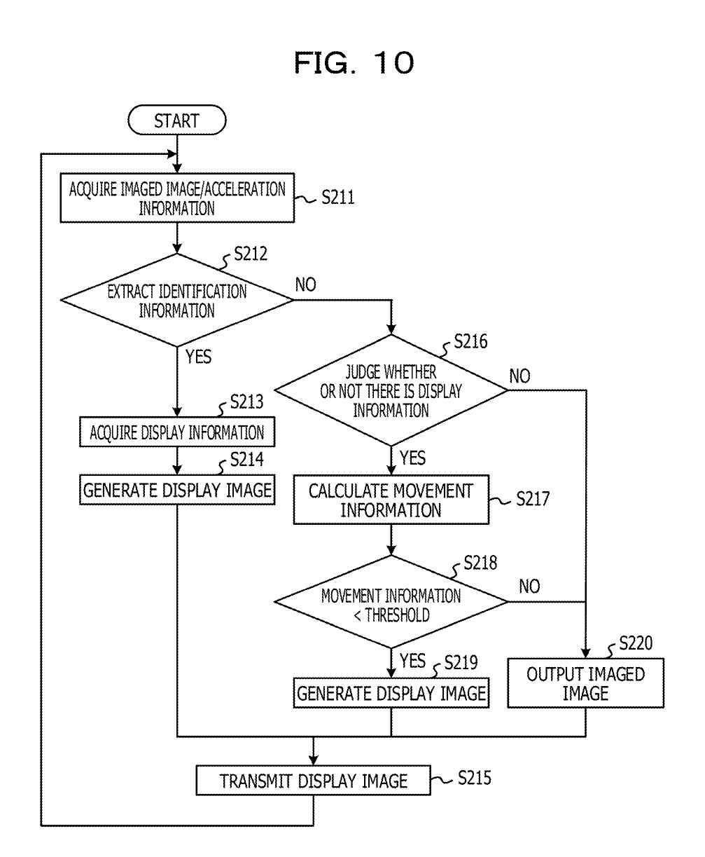

A processing flow of the information processing system according to the second embodiment is described with reference to FIG. 8, FIG. 9, and FIG. 10. FIG. 8 is an example of a flow chart of processing of the head-mounted display 100 according to the second embodiment.

A control unit 102 of the head-mounted display 100 acquires an imaged image (S111) which is imaged by an imaging unit 105 using a camera 15. The control unit 102 acquires acceleration information (S112) from an acceleration detection unit 107 using an acceleration sensor 17. FIG. 9 illustrates the acceleration information. The control unit 102 transmits the imaged image (S113) to a smartphone 200 and transmits the acceleration information (S114) to the smartphone 200. The control unit 102 waits till the control unit 102 receives from the smartphone 200 a display image (S115) to be displayed on a display 16.

The control unit 102 receives the display image (S116) transmitted from the smartphone 200 via a radio communication unit 101 and presents the received display image (S117) on a display unit 106.

FIG. 9 is a view illustrating the detected acceleration information. The acceleration sensor 17 of this example detects acceleration every 0.2 second. Acceleration received by the acceleration sensor 17 is classified to X-axis, Y-axis, and Z-axis directions. A numeric value of the X-axis represents acceleration (m/s²) received from the right side of the head-mounted display 100. A numeric value of the Y-axis represents acceleration (m/s²) received from the upper side. A numeric value of the Z-axis represents acceleration (m/s²) received from the front side. The acceleration information illustrated in FIG. 9 indicates detected time (time) and the acceleration (m/s²) received on the X-axis, the Y-axis, and the Z-axis.

FIG. 10 is an example of a flow chart of processing of the smartphone 200 according to the second embodiment.

An image acquisition unit 202 of the smartphone 200 acquires an imaged image and acceleration information (S211) from the head-mounted display 100 via a radio communication unit 201.

An identification information extraction unit 203 extracts identification information such as an ID of the AR marker illustrated in FIG. 3 from the imaged image acquired by the image acquisition unit 202 (S212). If the AR marker is included in the imaged image, the identification information of the AR marker is extracted (S212; Yes).

When the identification information is extracted by the identification information extraction unit 203, a display information acquisition unit 204 transmits the identification information to a server device 300 via the radio communication unit 201 and receives from the server device 300 and acquires AR display information associated with the identification information and definition information of the AR display information, which are stored in a DB 303 of the server device 300 (S213). Here, the control unit 302 of the server device 300 transmits the AR display information and the definition information of the AR display information in the DB 303 to the smartphone 200 (not illustrated), based on the identification information received via a radio communication unit 301. The AR display information is such content as manual display, an inspection result of last time and the like. In association with an ID of an AR marker, the definition information of the AR display information includes a name of AR display information, arrangement information on what position in a display image to arrange AR display information, and information indicating whether to display contents as AR display information.

Here, the display control unit 205 uses the acquired AR display information to generate a display image (S214) to be displayed on the head-mounted display 100. The display control unit 205 arranges contents, which is AR display information, in the display image based on the arrangement information of the definition information of the AR display information. The arrangement information is information indicating how far AR display information is to be arranged with respect to a predetermined point of the AR marker in directions X, Y, and Z.

The display control unit 205 transmits the generated display image (S215) to the head-mounted display 100 via the radio communication unit 201. The image acquisition unit 202 waits to acquire the imaged image again.

On the one hand, when the identification information is not extracted by the identification information extraction unit 203 (S212; No), the display control unit 205 judges whether or not there is any AR display information already acquired (S216).

When the display control unit 205 judges that there is AR display information (S216; Yes), the display control unit 205 uses the acquired acceleration information to calculate a distance (S217) that the head-mounted display 100 has moved. Because the distance that the head-mounted display has moved since extraction of the identification information was possible last time is obtained, the display control unit 205 calculates the movement distance, by double integrating acceleration that has been continuously acquired since extraction of the identification information was possible last time and calculating a sum of the acceleration.

Then, the display control unit 205 compares the movement distance, which is calculated movement information, with a threshold of a preset distance and judges whether or not the movement distance is smaller than the threshold (S218).

The display control unit 205 may use the acquired acceleration information to calculate an angle that the head-mounted display 100 has moved and compare the angle with a threshold. By comparing the movement information such as the movement distance and the movement angle of the head-mounted display 100 with the preset distance, the display control unit 205 judges whether or not to use the AR display information 600 to generate a display image.

A distance threshold is set by assuming in advance a distance that a user moves while performing work on a same object when the user performs the work.

When the display control unit 205 compares the movement distance, which is calculated movement information, with the threshold of the preset distance and judges that the movement distance is smaller than the threshold (S218; Yes), the display control unit 205 generates a display image to be transmitted to the head-mounted display 100, based on second position information from the AR display information acquired and displayed on the head-mounted display 100 last time (S219). The second position information is position information by which the AR display information 600 is displayed at a predetermined position in the display unit of the head-mounted display 100. The second position information may use a position where the AR display information is displayed when the AR marker is lastly acquired or may be predefined as such a position that the visibility of the user looking at a real image can be ensured, such as a position to the right or left of the display screen. The second information may also be determined when desired, from definition information for the AR marker such as information on which AR display information 600 is to be displayed, and how large and at which angle the AR display information 600 is to be displayed.

The display control unit 205 transmits the generated display image (S215) to the head-mounted display 100 via the radio communication unit 201. The image acquisition unit 202 waits to acquire the imaged image again.

In addition, if the display control unit 205 judges that there is no AR display information (S216; No), the display control unit 205 outputs the acquired imaged image (S220) and transmits the acquired imaged image (S215) to the head-mounted display 100 via the radio communication unit 201. This imaged image is a display image not including the AR display information. When a head-mounted display 100 of transparent type is used for the head-mounted display 100, a configuration may be such that the imaged image is not transmitted, and an instruction to cancel waiting for reception of the display image is transmitted so that the head-mounted display 100 does not display the display image. In this case, in the head-mounted display 100, no display image is received, waiting for reception of the display image is cancelled, and an imaged image is acquired again.

In addition, when the display control unit 205 compares the movement distance, which is calculated movement information, with the threshold of the preset distance and judges that the movement distance is not smaller than the threshold (S218; No), the display control unit 205 outputs the acquired imaged image (S220) and transmits the acquired imaged image (S215) to the head-mounted display 100 via the radio communication unit 201.

The information processing system according to the second embodiment continues to keep display of AR display information in a range in which a user works on an object to be manipulated. When it is judged that the user moves out of the work range, the information processing system according to the second embodiment cancels the display of the AR display information. This allows the AR display information to be displayed in the work range requested by the user and improves the visibility of the user wearing a head-mounted display 100 when the user does not desire the display of the AR display information.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention have been described in detail, it should be understood that the various changes, substitutions, and alterations could be made hereto without departing from the spirit and scope of the invention.

What is claimed is:

1. An information processing device configured to display a first display image on a display unit based on display information and first position information acquired based on identification information associated with the display information, the information processing device comprising:
a memory; and
a processor coupled to the memory, configured to:
acquire imaged images imaged by an imaging unit;
extract the identification information from an object included in each of the imaged image;
acquire the display information associated with the identification information when the identification information is extracted by the extraction; and
display a second display image on the display unit based on second position information and the display information acquired by the acquisition, when the identification information is not extracted from any of the imaged images acquired after the identification information is extracted by the extraction.

2. The information processing device according to claim 1, wherein
the first position information is position information with respect to the object from which the identification information is extracted, and
the second position information is position information indicating a certain position in a display range of the display unit.

3. The information processing device according to claim 1, wherein
when the identification information is not extracted from any of the imaged images by the extraction and when the display information is already acquired,
the processor:
calculates movement information indicating a movement of the imaging unit from a position where the imaged image from which the identification information is lastly extracted is acquired; and
judges, based on the calculated movement information, whether or not to display the second display image on the display unit based on the second position information and the already acquired display information.

4. The information processing device according to claim 3, wherein the movement information is a movement distance or a movement angle of the imaging unit.

5. The information processing device according to claim 3, wherein the processor uses output of an acceleration sensor to calculate the movement information.

6. The information processing device according to claim 3, wherein
the processor does not display the display image when the movement information exceeds a predefined first threshold.

7. The information processing device according to claim 3, wherein the processor changes the display image when the movement information exceeds a second threshold which is smaller than the first threshold.

8. The information processing device according to claim 1, wherein
the object is an augmented reality marker.

9. An information processing system configured to display a first display image on a display unit based on display information and first position information acquired based on identification information associated with the display information, the information processing system comprising:
a display device having an imaging unit and the display unit;
a storage device in which the display information associated with the identification information is stored; and
an information processing device having a memory, and a processor coupled to the memory, configured to acquire imaged images imaged by the imaging unit, extract the identification information from an object included in each of the imaged images, acquire from the storage device the display information associated with the identification information when the identification information is extracted by the extraction, and display a second display image based on second position information and the display information acquired by the acquisition when the identification information is not extracted from any of the imaged images acquired after the identification information is extracted by the extraction.

10. An information processing method for displaying a first display image on a display unit based on display information and first position information acquired based on identification associated with the display information, the information processing method comprising:
acquiring imaged images imaged by an imaging unit;
extracting the identification information from an object included in each of the imaged images;
acquiring the display information associated with the identification information when the identification information is extracted; and
displaying a second display image on the display unit based on second position information and the display information acquired by the display information acquisition unit, when the identification information is not extracted from any of the imaged images acquired after the identification information is extracted.
